(19) United States
(12) Patent Application Publication
(10) Pub. No.: US 2026/0252822 A1
(43) Pub. Date: Aug. 27, 2026

(54) Multilingual Task Evaluation System For Language Models

(71) Applicant: Oracle International Corporation, Redwood Shores, CA (US)

(72) Inventors: Amit Agarwal, Seattle, WA (US); Hansa Meghwani, Bengaluru (IN); Tao Sheng, Bellevue, WA (US)

(73) Assignee: Oracle International Corporation, Redwood Shores, CA (US)

(21) Appl. No.: 19/063,539

(22) Filed: Feb. 26, 2025

(51) Int. Cl. G06F 40/58; G06F 9/451

(52) U.S. Cl. CPC G06F 40/58; G06F 9/454

(57) ABSTRACT

Techniques for evaluating a language model for multilingual performance are disclosed. A framework generates prompts having components in a first language and in a different language. The different components include at least: a question, instruction, context, or instructed response language. The prompts test an ability of an LLM to respond in a specified language, an ability of the LLM to reason correctly, and/or an ability of the LLM to respond consistently. The framework calculates language token scores and fine-tuning performance scores. The framework generates a total score by weighting a token score, fine-tuning performance score, and/or one or more task scores. The scores are usable as a criteria for deployment of an LLM, for selecting training data or techniques, or for determining training weights used during tuning of an LLM.

### TECHNICAL FIELD

The present disclosure relates to multilingual language model evaluation.

### BACKGROUND

Large language models (LLMs) are advanced AI systems trained on vast amounts of text data to understand and generate human-like language. They process text using neural networks to enable tasks, such as translation, summarization, and conversation, by predicting contextually appropriate responses. Some LLMs have multilingual capability that arises from training on diverse text datasets. However, challenges include uneven data availability, which can cause biases that favor well-represented languages and disfavor less-represented languages. Evaluating multilingual performance is also difficult due to a lack of standardized benchmarks across languages and varying linguistic structures that complicate assessment.

Techniques in this disclosure may address the aforementioned flaws, challenges, and difficulties. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multilingual task evaluation system in accordance with one or more embodiments;

FIGS. 2A-C illustrate example sets of operations for multilingual task evaluation in accordance with one or more embodiments;

FIG. 3A-G illustrate example multilingual task evaluation techniques in accordance with one or more embodiments;

FIG. 4 illustrates an example machine learning engine in accordance with one or more embodiments;

FIG. 5 illustrates example operations for machine learning in accordance with one or more embodiments; and

FIG. 6 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE MULTILINGUAL MODEL EVALUATION SYSTEM
3. EXAMPLE OPERATIONS FOR MULTILINGUAL MODEL EVALUATION
   3.1 Example multilingual model evaluation operations
   3.2 Example multilingual token score evaluation operations
   3.3 Example fine-tuning performance evaluation operations
4. EXAMPLE MULTILINGUAL TASK EVALUATION TECHNIQUES
   4.1 Example instruction following prompts
   4.2 Example reasoning and correctness prompts
   4.3 Example response consistency prompts
   4.4 Example multilingual task evaluation, evaluation-based LLM selection, evaluation-based LLM tuning, and evaluation-based LLM deployment
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

While this General Overview section provides a general overview, additional embodiments and related combinations of features may be described in this Specification and/or recited in the claims outside of this General Overview section.

Due to the concentration of research and development in large language models (LLMs) being concentrated in English, a significant disparity exists between the capabilities of English LLMs and other language LLMs. This imbalance restricts the applicability and utility of traditional LLMs in multilingual contexts. Smaller language models often lack the robust reasoning and action planning capabilities needed to manage multilingual queries, particularly when tasks involve application programming interface (API) calls, complex processes, coordination, and/or planning. The gap in traditional Retrieval Augmented Generation (RAG) capabilities across LLMs of multiple languages limits the ability to provide consistent and high-quality responses. Further, a gap in capabilities across different languages for LLMs limits multilingual agentic systems. Embodiments of the multilingual task evaluation system are suitable for evaluating LLMs for multilingual tasks for RAG systems, agentic systems, and/or other LLM systems which may not may not currently exist. Some LLMs transfer knowledge from high-resource languages to less-represented ones (such as from English to another language) to enable cross-lingual translation and multilingual information retrieval tasks. Using a framework for analyzing, scoring, and/or selecting a model improves multilingual or multilingual performance for systems using one or more language models.

In embodiments, a multilingual task evaluation system scores a model's ability to complete various types of multilingual tasks and evaluates a model based on the scores. The system constructs prompts including instructions, contextual information, and/or requests to respond in different languages. Outputs generated by various models in response to the prompts are scored and/or weighted. Other attributes of the models, such as token count or token ratio, are scored and/or weighted as well in various embodiments. Models are scored for various attributes by language and/or task type, facilitating choice of the best model for a particular language and/or task type.

The various multilingual language model evaluation techniques reduce evaluation time and costs by streamlining the evaluation process, leading to faster deployment of high-quality multilingual artificial intelligence (AI) models. Also, the techniques ensure that AI products perform effectively across multiple languages and facilitate selection of the best open-source or closed-source models for deployment in a particular service or application. Metrics and/or feedback generated by the framework facilitate automated evaluation and/or manual review for multilingual capabilities of various models.

### 2. Example Multilingual Model Evaluation System

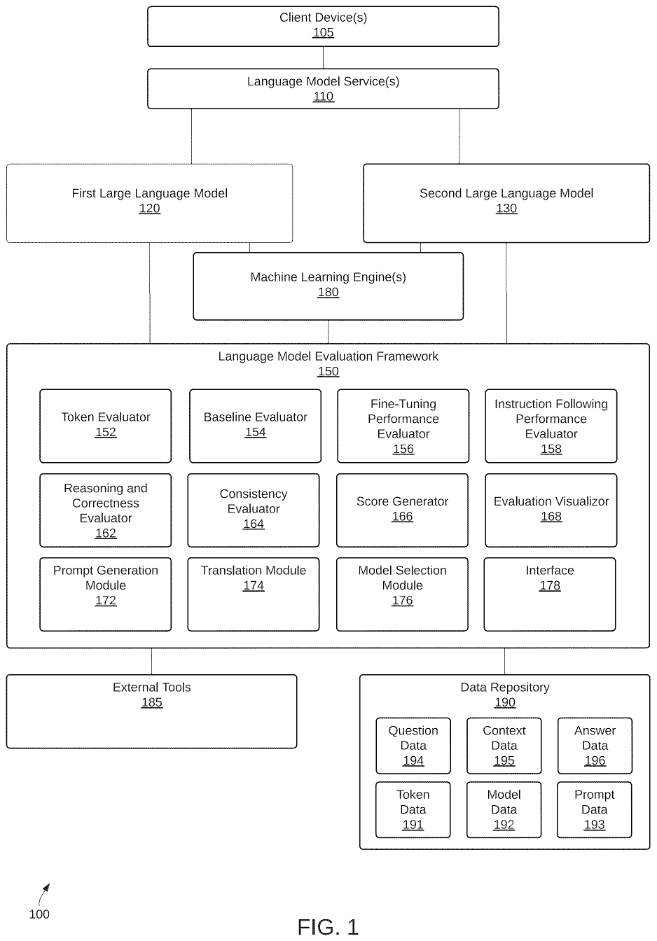

FIG. 1 illustrates an example multilingual model evaluation system 100. The system 100 is configured for evaluating a model for multilingual performance. In various embodiments, the system 100 may include more or fewer components than the components illustrated in FIG. 1. In various embodiments, the components illustrated in FIG. 1 are local to or remote from each other. The components illustrated in FIG. 1 are implemented in software and/or hardware. The components are distributed over multiple applications and/or machines. Multiple components may be combined into one application and/or machine. Operations described with respect to one component may instead be performed by another component or combination of components.

In FIG. 1, a language model evaluation system 100 includes a client device 105, one or more language model services 110, a first language model 120, a second language model 130, a language model evaluation framework 150, a machine learning engine 180, external tools 185, and a data repository 190. The language model framework 150 includes various components and modules to facilitate generating scores and/or metrics for different models.

The client device 105 represents a computing device, such as a computer, smart phone, or tablet, having a user interface, where users interact with the system, that allows users to input text or commands that are processed by other components of the system 100. The one or more language model services 110 utilize either the first language model 120, the second language model 130, or another language model to perform various tasks, such as summarization, agentic task performance, response generation, question answering, and/or other natural language processing functions, for the one or more language model services 110.

For example, the client device 105, which includes network components and/or other components for communicating with the model evaluator, displays a visualization of a model evaluation for one or more models. For example, the system displays information, such as evaluation scores, about different language models, such as first LLM 120 and/or second LLM 130, in a graphical user interface (GUI) on a display of the client device 105. In embodiments, the client device 105 receives one or more scores that are visualizable in a GUI for a particular model for a particular language and/or for a task type.

In an embodiment, the language model evaluation framework 150 is in communication with a data repository 190. In an embodiment, the language model evaluation framework 150 is in communication with a first language model data repository for the first LLM 120 and a second language model data repository for the second LLM 130. The language model evaluation framework 150 is also in communication with one or more machine learning engines 180 configured for training, fine-tuning, optimizing, and/or performing other machine learning operations on an LLM. Although two models, the first LLM 120 and second LLM 130, are shown in FIG. 1, various embodiments include one model or a greater plurality of models. Models, such as GPT-4, BERT 2, Claude, Claude 2, LlaMa, DeepSeek-R1, and/or various other open-source and/or closed-source models, are suitable for use with the system 100.

The language model evaluation framework 150 evaluates the performance of the language models by performing various tests and prompts as well as by measuring and generating metrics for models. The language model evaluation framework 150 includes modules for assessing aspects of a particular language model, such as accuracy and/or efficiency in tasks, like reasoning or instruction following. The language model evaluation framework 150 includes a token evaluator 152, a baseline evaluator 154, a fine-tuning performance evaluator 156, an instruction following performance evaluator 158, a reasoning and correctness evaluator 162, a consistency evaluator 164, a score generator 166, an evaluation visualizer 168, a prompt generation module 172, a translation module 174, a model selection module 176, and an interface 178.

The token evaluator 152 includes a language token counting module for generating information regarding the token count and/or token composition of a particular language model. The token counting module determines a plurality of token counts for a plurality of languages for a model. The token evaluator 152 includes components for generating one or more token scores for a plurality of languages for a plurality of models.

The baseline evaluator 154 includes modules to test different language models'performances on various tasks without or before a particular round of fine-tuning. Metrics, such as Bilingual Evaluation Study (BLEU) or Recall-Oriented Understudy of Gisting Evaluation (ROUGE), are used to measure how well the model performs in a control or base setting, providing a basis of comparison for further evaluations. BLEU is suited for tasks where precision is important, such as machine translation, where it is necessary to generate grammatically and contextually correct sentences. On the other hand, ROUGE is recall-oriented and suited for summarization tasks, where it is more important to capture key points rather than the exact phrasing. In various embodiments, the baseline evaluator 154 determines one or more of an instruction following score, a reasoning and correctness score, a consistency score, and/or a token score computed for one or more different multilingual language models.

The fine-tuning performance evaluator 156 includes modules that test different language models'performance on various tasks after one or more fine-tuning stages and/or after other machine learning operations. In various embodiments, the fine-tuning performance evaluator 156 evaluates a plurality of models after one or more particular machine learning frameworks have been used to train the models. The fine-tuning performance evaluator 156 evaluates the capability of the different models to be improved by fine-tuning using the various machine learning techniques. The fine-tuning performance evaluator 156 evaluates various machine learning techniques for effectiveness in improving the various language models. In various embodiments, the fine-tuning performance evaluator 156 determines a metric value, an instruction following score, a reasoning and correctness score, a consistency score, and/or a token score computed for one or more different multilingual language models and/or combinations thereof.

In embodiments, the fine-tuning performance evaluator 156 includes modules for interfacing with one or more machine learning and/or reinforcement learning frameworks. For example, the fine-tuning performance evaluator 156 includes or is interfaced with a parameter efficient fine-tuning (PEFT) fine-tuning module, a vocabulary extension module, an instruction tuning module, and/or other fine-tuning modules. In an embodiment, the fine-tuning performance evaluator 156 determines an accuracy or performance score for different models before and after fine-tuning to rate the effectiveness of fine-tuning. Models for which a large improvement occurs are assigned a higher score such as a score corresponding to an improvement difference or ratio.

The instruction following performance evaluator 158 includes modules that execute one or more prompts against target models that evaluate the model's abilities to follow instructions as opposed to reasoning, correctness and/or consistency. The instruction following performance evaluator 158 uses prompts, including tasks from a pool of instruction following tasks. In embodiments, an instruction following task is a unique task type that is different from other tasks of a different type, so the instruction following evaluator 158 primarily tests instruction following.

The reasoning and correctness evaluator 162 includes modules that execute one or more prompts against target models that assess the model's abilities to perform tasks primarily involving reasoning and/or correctness as opposed to instruction following tasks and/or consistency tasks. In embodiments, a reasoning and correctness task is identified from tasks of different types, so the reasoning and correctness evaluator 162 primarily tests reasoning and correctness. In various embodiments, reasoning and correctness are evaluated using metrics such as the F1 score, which balances precision and recall; precision, which measures the accuracy of positive predictions; recall, which assesses the proportion of actual positives correctly identified; error rate, which indicates the percentage of incorrect predictions; or a combination of these measures.

The consistency evaluator 164 includes modules for consistency testing of responses of a model across languages. The consistency evaluator 164 includes modules that execute one or more prompts against target models that evaluate the model's abilities to respond with semantically consistent answers. For example, the consistency evaluator prompts a plurality of models in a plurality of languages using translated prompts in the plurality of languages. The consistency evaluator 164 analyzes the responses of the plurality of models using various algorithms and/or scoring metrics. In embodiments, a consistency task is identified from tasks of different types, so the consistency evaluator 165 primarily tests consistency.

The score generator 166 includes modules to receive scores and metrics for the plurality of models and create scores of one or more types for the models. For example, the score generator weighs a token score, a fine-tuning performance score, an instruction-following score, a reasoning and correctness score, a consistency score, another score, or combinations thereof to generate one or more scores for a particular LLM. In embodiments, the framework 150 generates a plurality of scores corresponding to a plurality of languages assessed by the framework. In embodiments, the framework 150 tests a plurality of models and generates a respective plurality of composite scores for the plurality of models for one or more languages.

The evaluation visualizer 168 includes modules for rendering and/or visualizing scores and/or metrics for various language models. For example, the evaluation visualizer groups, clusters, classifies, and/or renders the various scores for a model into a visualization of a GUI. The GUI is accessible by a user to view, explore, and/or manage visualizations, patterns, and/or trends of the scores for the models.

The prompt generation module 172 generates one or more prompts, including instructions, context, and/or a request to answer in a particular language. One or more of the components (e.g., an instruction, a context, a question, and/or a requested answer) is in a different language other than another component of the prompt. Prompts generated by the prompt generation module therefore have components in different languages that cause a model to perform tasks in at least two languages.

The translation module 174 includes general and/or specialized language translation models that translate from a language to one or more other languages. The translation module includes algorithms and/or machine learning models that identify a language and/or provide a semantic equivalent in one or more different languages.

The model selection module 176 selects, recommends, or indicates a particular language model based on one or more criteria associated with a particular task or query. For example, one or more criteria are applied to determine a weighting of one or more scores generated by the language model evaluation framework 150 used to rank a plurality of models scored by the framework 150. In embodiments, the ranking (or a recommendation, suggestion, etc.) is provided to a user via a GUI score or metric on which the selection is made is visualized and presented in the GUI with a recommendation or another indication of the selection.

The machine learning engine 180 trains and/or fine-tunes one or more language models, such as the first model 120a or the second model 120b. The system 100 records model performance scores before and after fine-tuning and/or feedback-based optimization of the first model 120a and/or the second model 120b to measure a change in performance (e.g., a change in accuracy or efficacy) based on the fine-tuning or optimization. The results are recorded for the respective models. The machine learning engine 180 utilizes data from various repositories to train and improve the language models 120a and 120b, or one or more other models, enhancing their capabilities over time through application of machine learning algorithms.

The language model evaluation framework 150 includes interface 178. The interface 178 facilitates communicating with external computing devices and input/output operations. The interface 178 refers to hardware and/or software configured to facilitate communication between a user device and a system. In FIG. 1, an interface 178 is used to facilitate communication between the language model evaluation framework 150 and other components of the system or external components. Such an interface 178 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

External tools 185 include frameworks that enable agents and/or agentic systems to perform tasks such as planning, learning, and decision-making. In various embodiments, these tools include, for example: reinforcement learning frameworks that allow agents to learn optimal behaviors through trial and error by receiving rewards or penalties based on their actions; natural language processing tools that enable agents to understand and generate human language; autonomous navigation systems help agents, like robots or self-driving cars, navigate physical environments by processing sensory input and/or making real-time decisions; Multi-agent systems tools that enable coordination between multiple autonomous agents, where they can negotiate, collaborate, or compete to achieve collective or individual goals; Planning tools that allow agents to generate sequences of actions to reach a specific objective, factoring in constraints and uncertainties. These agentic tools, in combination with a multilingual language model evaluation framework, enable an agentic system to assess and improve the performance of its language models, improving performance and ensuring that the system's behavior aligns across languages.

In embodiments, a language model evaluation framework data repository 190 stores data accessed or generated by the language model evaluation framework 150. Generally, the data repository 190 stores data loaded onto the language model evaluation framework 150 and/or another component of the system 100. The language model evaluation data repository 190 optionally stores data loaded from other sources. In various embodiments, the external data storage service stores one or more types of data including, but not limited to, document data, query data, response data, source data, user data, asset data, language model data, language model metadata, language model training parameters, and/or the like.

As shown, the data repository includes token data 191, model data 192, prompt data 193, question data 194, context data 195, and answer data 196. Token data 191 refers to information related to tokens, token counts, vocabularies, words, subwords, etc., of various LLMs. Model data 192 includes other data related to LLMs, such as metadata, parameter number, token limits, etc. Prompt data 193 refers to generated and/or input prompts that include one or more of a question, instructions, and/or a context (e.g., a body of text accompanying the prompt). Question data 194 refers to data associated with questions that are selectable for a prompt and/or which are answerable by context data 195 and/or answer data 196. Context data 195 refers to information (e.g., document chunks, text, images, etc.) that is provided in a prompt with a question and referred to in the questions and/or instructions of the prompt. Answer data 196 refers to ground truth answers that are stored in association with respective questions for which the ground truth answers are considered valid responses. In various embodiments, data is separately stored for and/or organized by different languages, model types, task types, and/or deployment scenarios.

In an embodiment, the language model evaluation framework 150 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Example Operations For Multilingual Model Evaluation

### 3.1. Example Multilingual Model Evaluation Operations

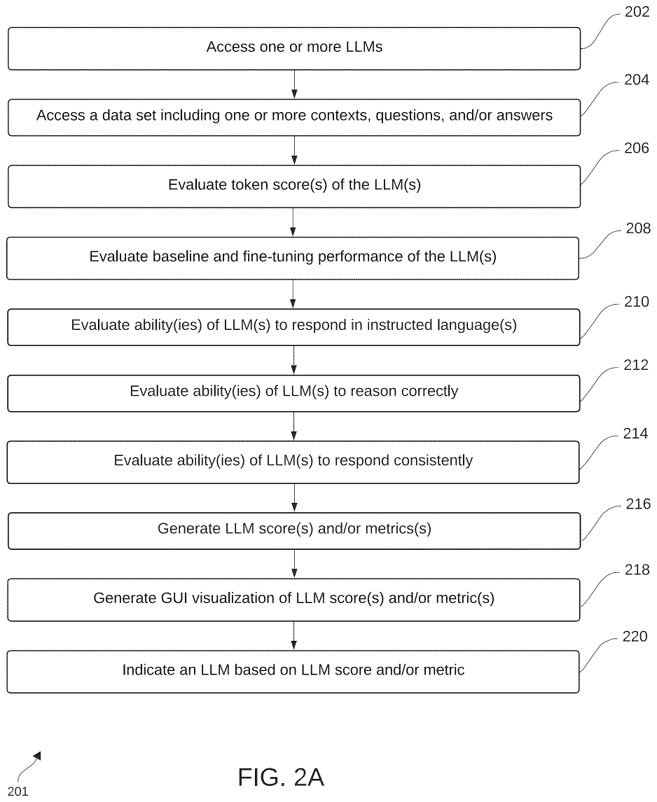

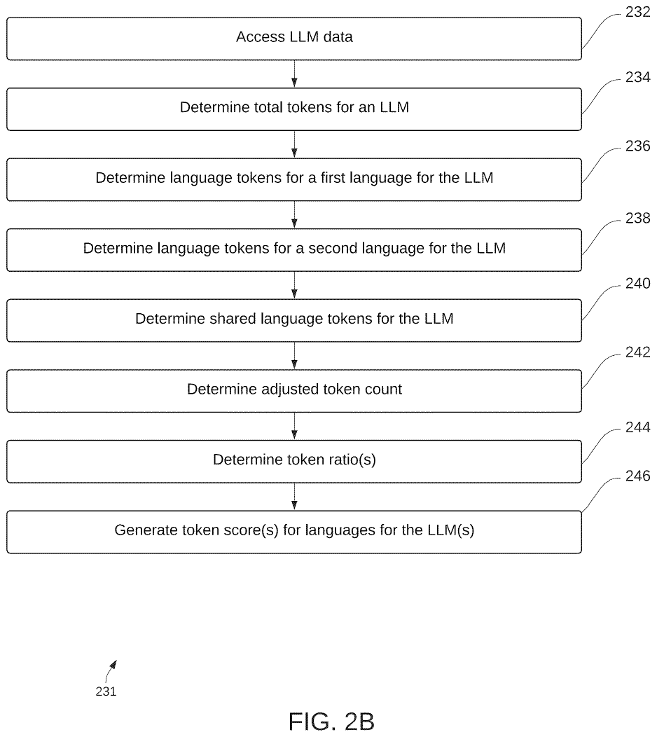

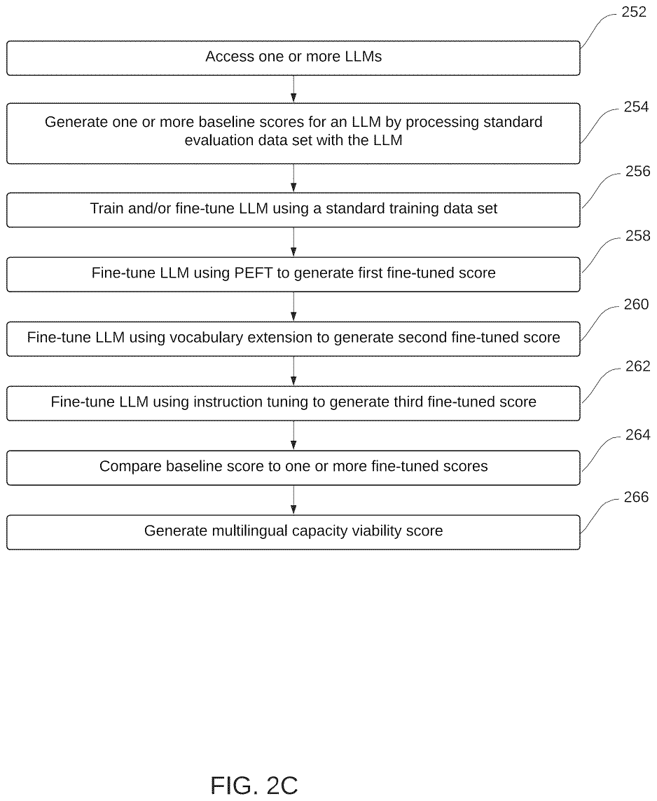

FIG. 2A illustrates example operations 201 for multilingual task evaluation of a language model. For example, operations 201 are performable by the language model evaluation framework 150 and/or components of the system 100 of FIG. 1.

In FIG. 2A, a language model evaluation framework accesses one or more LLMs (Operation 202). For example, different LLMs that are available publicly and/or as open source are suitable for being evaluated. Other models, including smaller models and/or closed-sourced language models, are also suitable for being evaluated by the language model evaluation framework of various embodiments.

The language model evaluation framework accesses a data set that includes one or more contexts, questions, and/or answers (Operation 204). In various embodiments, the evaluation framework accesses a data set having a plurality of documents that are usable as a context that is included with a prompt for a language model to respond to a question included in the prompt with the plurality of documents as context. The evaluation framework accesses a set of one or more contexts, one or more questions, and/or one or more ground truth answers to the question(s) that are semantic equivalents in different languages. In some embodiments, the evaluation framework translates documents to generate training semantically equivalent contexts, questions, and/or ground truths in different languages.

The language model evaluation framework evaluates one or more token scores of the LLM(s) (Operation 206). For example, the system generates a plurality of token scores for a plurality of languages based on language-specific token counts, shared token counts, and language-specific vocabularies for the plurality of languages for the model. Evaluating the one or more token scores of the LLM(s) is described further in FIG. 2B, below.

The language model evaluation framework evaluates a baseline performance and a fine-tuning performance (Operation 208). For example, the language model evaluation framework evaluates an initial, or baseline, performance of a pretrained model. The language model evaluation framework performs one or more fine-tuning techniques on the pretrained model. The language model evaluation framework determines one or more respective fine-tuning performance scores for the one or more fine-tuning techniques and one or more differences in scores before and after the fine-tuning. Evaluating baseline and fine-tuning performance of the LLM(s) is described further in section 3.2 in FIG. 2C, below.

The language model evaluation framework evaluates the ability of the LLM(s) to respond in an instructed language (Operation 210). In this operation, the framework generates one or more prompts comprising instructions to generate one or more specified responses in one or more specified languages based on one or more contexts and/or one or more questions that have semantic equivalents in different languages. The framework generates responses by providing the prompts as input into the LLM(s).

For example, a prompt generator generates a plurality of prompts with instructions in a first language requesting a response in a different language. In some embodiments, a context in the first language, the second language, or another language is provided with a query in the prompt, which is in the first language, the second language, or another language, respectively. The system scores the results of executing the prompts for correctness of the response in terms of being in the correct language. In embodiments, the framework generates a plurality of scores respectively based on the results of a plurality of LLMs.

In an example, an instruction following task is included in a prompt. The prompt includes different languages. The prompt includes a data set including contexts (e.g., documents) that are semantic equivalents between the different languages. The language model evaluation framework inputs the semantically equivalent questions and/or contexts into the LLM(s) with instructions telling the model to answer in a specified language. The response is scored for whether or not the response is in the specified language. In this way, reasoning and semantic consistency are controlled, and the system separately evaluates instruction following. Example instruction following prompts are discussed in section 4.1.1, below.

The language model evaluation framework evaluates the ability of the LLM(s) to reason correctly (Operation 212). In this operation, the language model evaluation framework inputs a correct reasoning task prompt into the LLM(s). For example, semantically equivalent questions and/or semantically equivalent contexts for different languages are included in a prompt with an instruction to answer whether or not the context includes an answer to the question. In this way, correct reasoning is tested. Example reasoning and correctness prompts are discussed in section 4.1.2, below.

The language model evaluation framework evaluates the ability of the LLM(s) to respond consistently (Operation 214). In this operation, the language model evaluation framework inputs a consistency task prompt into the LLM(s). For example, a prompt includes a context (e.g., a document) comprised of semantically equivalent questions in different languages. Responses to the questions in the prompt are scored based on semantic similarity to respective ground truths in the different languages. Example response consistency prompts are discussed in section 4.1.3, below.

In general, the framework generates the task scores for instruction following, reasoning and correctness, and consistency based on an accuracy percentage of responses to questions included in a prompt that require the LLM to perform the various task types. For example, using a prompt, the system evaluates an LLM for a first language and a second language. The LLM responds correctly to seven out of ten questions for a multilingual consistency task for the first language included and eight out of ten questions for the multilingual consistency task for the second language. As a result, the LLM is assigned a score of seventy for multilingual consistency for the language and eighty for multilingual consistency for the second language.

The language model evaluation framework generates one or more scores and/or metrics for the LLM(s) (Operation 216). In an embodiment, the framework generates a token score, a fine-tuning performance score, a multilingual instruction-following score, a multilingual reasoning and correctness task score, and a multilingual consistency task score.

In this example, the fine-tuning performance score is generated based on combining a plurality of fine-tuning performance scores for a plurality of fine-tuning techniques. The framework combines the token score and the fine-tuning score to determine a multilingual capacity score for the different languages of the LLM(s). A high token score for a language indicates that a base model has a high vocabulary support with needing to add tokens. A high-fine tuning score indicates that the base model is likely to benefit from additional training.

In embodiments, the multilingual capacity score is used as a condition for selecting a model for training and/or fine-tuning. In this example, the framework uses the multilingual capacity score to determine whether a base model is selected for a round of training and/or fine-tuning or for a particular language or a particular use case. For example, the framework evaluates a plurality of LLM(s) in a pipeline, and LLM(s) are selected based on meeting a condition or criterion (e.g., being above a 50^{th} or 85^{th} percentile, performing best or second best, and/or another criterion, etc.).

In embodiments, the system selects a corpus of training data for fine-tuning wherein the composition of the corpus of training data is based on the instruction-following score, reasoning score, and/or consistency score. The training data is used to selectively fine-tine LLMs with a sufficient multilingual capacity score for different types of tasks and for different languages. For example, an additional weight is applied to training data that corresponds to a low-scoring task type and/or a low-scoring language.

The model evaluation framework generates a GUI visualization of one or more LLM scores and/or metrics (Operation 218). In embodiments, the system generates a GUI displaying the LLM(s), scores, patterns, or trends for the scores in a GUI element that organizes the scores by language, LLM type, score type, etc. The GUI presents LLMs organized by scores, such as multilingual capacity score and/or scores for performance, for a language and/or a task type.

The model evaluation framework indicates an LLM based on an LLM score and/or metric (Operation 220). For example, a user selects a language by interacting with a GUI generated by the framework. Responsive to a particular language being selected by the user, the evaluation framework ranks the models by scores for that language and/or indicates models meeting or exceeding one or more threshold scores for that language. In some cases, the GUI indicates a plurality of task type scores for a plurality of LLMs. In another example, an LLM with a highest score for a particular language and/or task type is indicated. Alternatively, in some embodiments, the evaluation framework does not indicate an LLM that does not meet or exceed a required score(s). In embodiments, the model evaluation framework is automated, so an LLM is approved, deployed, or moved to a next phase based on meeting or exceeding the required score(s) and/or not approved, deployed, or moved to a next phase based on not meeting or exceeding the required score(s).

### 3.2 Example Multilingual Token Score Evaluation Operations

FIG. 2B illustrates example operations 231 for multilingual token score evaluation of a language model. The language model evaluation framework accesses LLM-related data (Operation 232). For example, metadata for a language model includes a total token count and/or vocabulary. The vocabulary of an LLM includes words in different languages. In general, language tokens correspond to a word or subword in an LLM's vocabulary.

The size and diversity of a model's vocabulary directly impacts its ability to understand and generate text in multiple languages. A comprehensive vocabulary helps the model to recognize and process words from various languages. The percentage of tokens dedicated to languages in a set of training data often reflects the model's capacity to handle multilingual input effectively.

Multilingual models sometimes encounter rare or unique words, especially in lower-resource languages. A robust vocabulary and token embedding facilitate these words being appropriately represented.

In some models, the majority of tokens are from the English language, and the distribution percentage of tokens in other language (such as Spanish, French, German, and/or Chinese) tokens is less. For a particular use case involving a set of languages, the language model evaluation framework evaluates LLMs for the set of languages. For example, for a user case involving English, Spanish, French, German, and Chinese languages, tokens from other languages are classified as “other tokens.”

The language model evaluation framework determines the total tokens for the LLM (Operation 234). Different languages are tokenized in distinct ways, with models using methods like Byte Pair Encoding (BPE) or WordPiece, which result in varying token counts based on the language's structure. In various embodiments, a total token count is determined by examining the source code of and/or by testing a public-facing endpoint hosting a private LLM. In embodiments, A token count for an LLM is determined by analyzing a model's tokenizer, input layer, and/or embedding layer. For example, by accessing a tokenized form of an input text and counting the resulting tokens, a token count for the LLM is obtained.

The language model evaluation framework determines the language token count for a first language (Operation 236). In embodiments, the language model evaluation framework determines language token counts for languages of a set of languages and another language token count for other languages. In embodiments, one or more languages are high-resource languages for an LLM. High-resource languages are languages having the largest vocabulary or token count for a particular LLM. For example, the language model evaluation framework determines a language token count for a first language such as English (or another language).

The language model evaluation framework determines language tokens for a second language for the LLM (Operation 238). For example, the language model evaluation framework determines a language token count for one or more second languages, such as Spanish, French, German, and Chinese (or other languages).

The language model evaluation framework determines shared language tokens for the LLM (Operation 240). For various language models, a token is a word or subword unit. For word tokens, a token is considered a shared token if the token is both a word in the vocabulary of the first language and a word in the vocabulary of the second language. For subword tokens, a token is a shared token if the token is both a part of a word in the first language and a part of a word in the second language. In some embodiments, the language model evaluation framework determines a count of unique tokens for a language by not counting shared tokens that are shared with another language. In embodiments, the language model evaluation framework determines a count of tokens for a language by not counting shared tokens that are shared with the first language. Shared language tokens between second languages are or are not counted for a particular language, depending on the embodiment.

The language model evaluation framework determines an adjusted token count (Operation 242). In some embodiments, shared tokens are discarded from both the count of tokens for the first language and the count of tokens for the second language, resulting in an adjusted token count for the first language and/or an adjusted token count for the second language. In some embodiments, a particular language is a high-resource language, and a plurality of secondary languages are lower-resource languages. In some embodiments, the language model evaluation framework removes tokens of the plurality of secondary languages that are shared tokens with the primary language from counts of the tokens of the plurality of secondary languages to determine adjusted token counts.

The language model evaluation framework determines one or more token ratios (Operation 244). In this operation, the language model evaluation framework uses adjusted token counts for the languages to determine token ratios for LLMs for the languages. For example, a token count for an LLM includes 80% English tokens and 20% French tokens. However, after accounting for shared tokens, the ratio of adjusted English token count to adjusted French token count is 9:1. Ratios for a plurality of languages and a plurality of models are visualizable using a pie chart.

The language model evaluation framework generates one or more token scores for languages for the LLM (Operation 246). In various embodiments, a total token score is generated by combining a plurality of token scores for different languages for an LLM. The token scores are averaged using a mean or weighted average of the scores to result in a total score. In some embodiments, scores are generated for groups of one or more languages (e.g., for languages grouped by alphabet used for the language or by whether the language is high resource). The token scores are combined with baseline and fine-tuning scores to determine a multilingual capacity or viability score of an LLM. The multilingual capacity or viability score is usable as a condition to determine if and how an LLM is fine-tuned and if the LLM meets one or more criteria for deployment.

### 3.3 Example Fine-Tuning Performance Evaluation Operations

FIG. 2C illustrates example fine-turning performance evaluation operations for a multilingual LLM. The language model evaluation framework accesses one or more LLMs (Operation 252).

The language model evaluation framework generates one or more baseline scores for an LLM by processing an evaluation data set with the LLM (Operation 254). For example, the system inputs a standard evaluation data set, or another data set, into the LLM and scores the output based on a standard scoring for the standard evaluation data set and/or an evaluation template for another data set. To improve benchmarks, such as the large model systems organization (LMSYS) benchmark or the OpenLLM Leaderboard benchmark, the language model evaluation framework augments standard evaluation data sets with private or synthetic data.

The language model evaluation framework composes a data set comprising triplets that include (a) a question, statement, or topic, (b) one or more documents or other data as context, and (c) a ground truth answer. In this example, the ground truth answer is the standard of correctness for responses to the question, topic, or statement based on the one or more documents or other data. In other embodiments, the triplets have semantic equivalents in different languages in the data set.

An example prompt for assessing baseline performance is as follows:
Prompt: “You will be presented with a question and several contexts containing information about the question. Read and understand the contexts carefully. If any of the contexts directly answers the question, respond as ‘Yes, the contexts answer the question’ otherwise ‘No, the contexts don't answer the question’
Question: {question}
Contexts:
{Topic Title}: {Topic Text}
{Topic Title}: {Topic Text}
{Topic Title}: {Topic Text}
{Topic Title}: {Topic Text}
{Topic Title}: {Topic Text}
Answer:”

The baseline performance is evaluated against the ground truth from the data set to determine accuracy as a metric. To maintain consistency, languages have the instruction part of the prompt in English, so the models are compared equally. In embodiments, the instructions are in a high-resource language. In other embodiments, however, the instructions are consistent with a language of a questions and/or document (i.e., a document chunk including {topic title} text that is associated with a topic title of the document chunk and {topic text} text that is associated with a body of the document chunk).

In various embodiments, the question parts are in the respective different languages (e.g., Arabic, English, Chinese, etc.). In the example, the topic title and topic text are also in the respective different languages, and the question and topics are related. In this example, accuracy in terms of a number of responses to a number of questions being an exact match to a respective number of ground truths is measured as a metric to measure baseline LLM performance.

The language model evaluation framework trains and/or fine-tunes the LLM using a training data set (Operation 256). For example, the system inputs a standard training data set, or another training data set, into a machine learning framework that performs one or more machine learning operations on the LLM using the training data. Several machine learning frameworks are discussed below. In embodiments, one or more training and/or fine-tuning techniques are applied, and scores the training and/or fine-tuning techniques are measured separately and/or averaged together.

In some embodiments, the system fine-tunes an LLM to increase its performance for a given use case, domain, or task to improve the model capability or behavior for the use case, domain, or task. For selecting LLMs for deployment from a multi-LLM pipeline, adaptability for downstream tasks, capacity for improvement, and/or future viability are important factors. The language model evaluation framework identifies LLMs for which subsequent training will impact existing capabilities of a pre-trained model. LLMs whose downstream capability in a task/domain increases after fine-tuning without showing regression in pretrained capabilities are preferred. The framework training the LLMs facilitates identifying LLMs that show good results in some tasks but show regression or degradation for one or more fine-tuning techniques.

The language model evaluation framework fine-tunes the LLM using PEFT to generate a first score (Operation 258). The language model evaluation framework performs PEFT fine-tuning on the LLM using the training data set and/or a set of pre-defined configurations or hyperparameters. The first score is generated based on evaluating the LLM using the evaluation data set. If fine-tuning leads to no change or drop in performance, that indicates possible instability of the LLM or divergence from its pre-training stages. Such models are eliminated from consideration for deployment in certain embodiments.

In various embodiments, the fine-tuned LLM is benchmarked against its baseline score for using standardized data sets for scoring (e.g., using LMSYS and/or OpenLLM leader scoring). The system flags LLMs that regress from original performance (for example, with a visual indicator in a GUI).

The language model evaluation framework fine-tunes the LLM using vocabulary extension to generate a second fine-tuned score (Operation 260). To increase the LLM's capability for a given language, the LLM's vocabulary is expanded by adding more tokens in an existing language or adding tokens from a new language and then finetuning the model with the tokens added. This technique is intended to increase the LLM's vocabulary and knowledge without hampering previous understanding or performance. The evaluation framework generates the second score based on evaluating the LLM after the vocabulary extension using the evaluation data set to test its performance. In embodiments, the framework runs regression tests against LMSYS and/or OpenLLM to score if the model's previous capabilities are retained.

The language model evaluation framework fine-tunes the LLM using instruction tuning to generate a third score (Operation 262). Other finetuning techniques directly perform supervised fine-tuning or instruction tuning on an LLM without adding new parameters as is done with PEFT techniques and vocabulary extension. After the direct supervised fine-tuning, the LLM is evaluated using a standard, private, or synthetic evaluation data set, and/or the system runs a regression test against LMSYS and/or OpenLLM.

The language model evaluation framework compares the baseline score to one or more fine-tuned scores (Operation 264). For example, the PEFT score, the vocabulary extension score, and the instruction tuning score are weighted and/or averaged, resulting in an overall fine-tuned LLM score. The difference between the baseline score and the fine-tuned LLM score results in a fine-tuning performance score. The evaluation framework saves the fine-tuning performance score as an indicator. For example, a poor fine-tuning performance score indicates that an LLM with poor instruction following, poor reasoning and correctness, and/or poor consistency is not viable for fine-tuning to improve performance in these tasks.

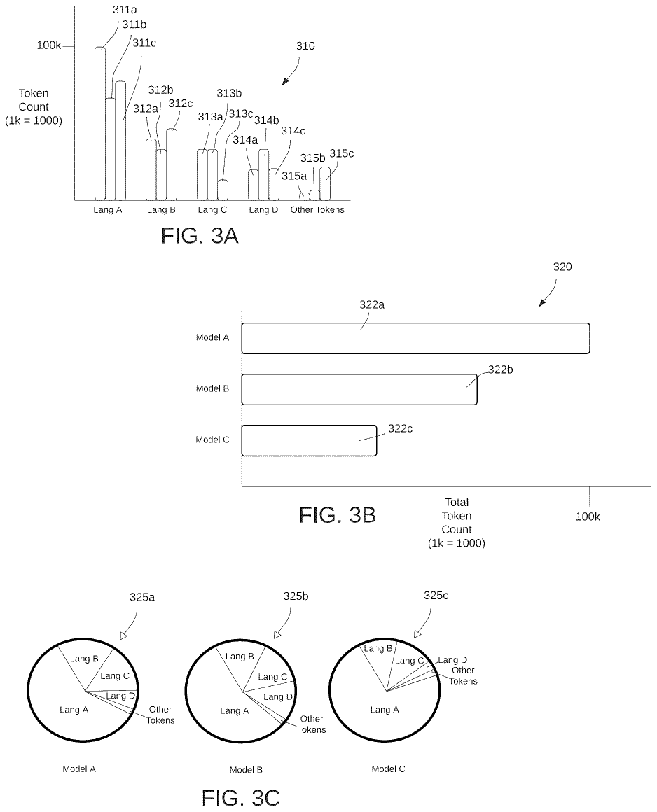

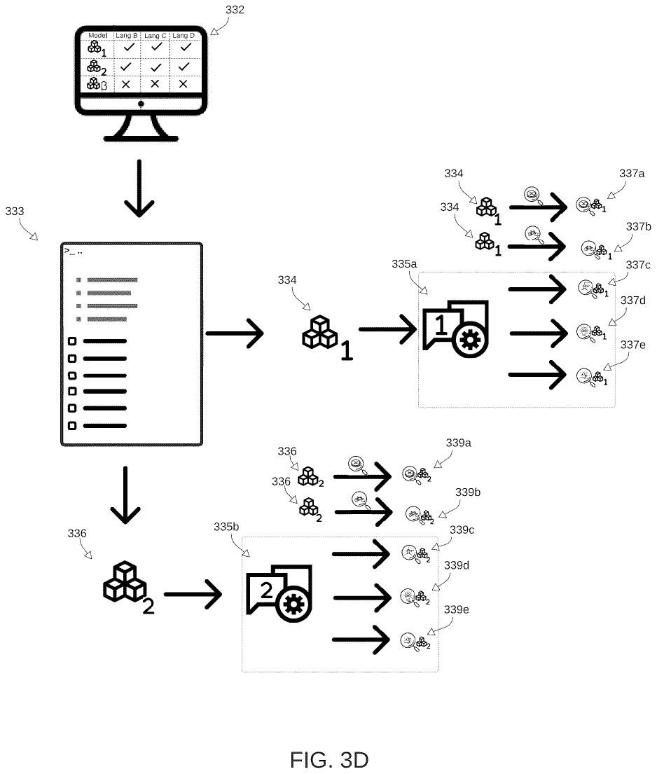

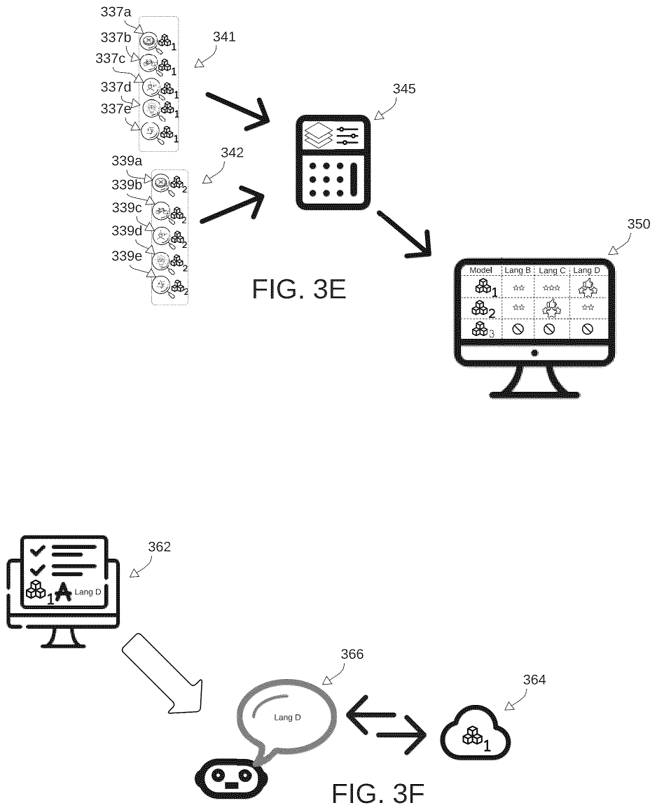

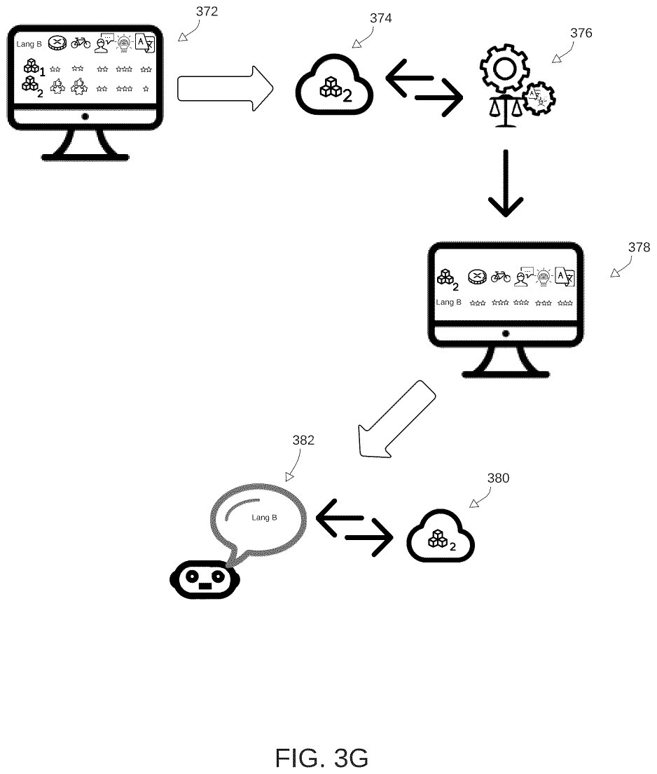

The language model evaluation framework generates a multilingual capacity viability score (Operation 266). In embodiments, the model evaluation framework assigns a failing score to an LLM that has a low token score or a low fine-tuning performance score. The model evaluation framework assigns a passing score to an LLM that has a high token score and a high fine-tuning performance score. For example, an LLM is not considered for fine-tuning because it does not have enough tokens and does not respond well to fine-tuning. Examples are considered with reference to FIGS. 3A-G in section 4.4 below.

### 4. Example Multilingual Task Evaluation Techniques

### 4.1 Example Instruction Following Prompts

In this example, in a baseline evaluation, an LLM is expected to respond in English either “Yes, the contexts answer the question” or “No, the contexts don't answer the question”. To further test the model's generation capability and ability to handle code-switching, the language model evaluation framework prompts the model to answer in different languages for evaluation. An example of such a prompt is as follows:
Prompt:
“You will be presented with a question and several contexts containing information about the question. Read and understand the contexts carefully. If any of the contexts directly answers the question, then respond to the question otherwise decline to answer it. You must respond in {Language}
Question: {question}
Contexts:
{Topic Title}: {Topic Text}
{Topic Title}: {Topic Text}
{Topic Title}: {Topic Text}
{Topic Title}: {Topic Text}
{Topic Title}: {Topic Text}”

In this example, the language model evaluation framework iterates the response generation five times with five different languages. In this example, the framework evaluates the language in which the model responds irrespective of the correctness of the response. If the LLM responds in the instructed {Language}, it is considered as an accurate response; otherwise, it is not considered an accurate response.
Case 1: In this scenario, the {Language} in which the Question is asked and the {Language} in which model is instructed to respond are the same. This is often the scenario where LLMs are used in chatbots or search applications where knowledge base (Topics) are in different language according to the available resources, but the end user wants to use another language to ask a question and wants the model to respond in the same language.
Case 2: In this scenario, the questions and topic are in a same language that is different from the {Language} in which the model is instructed to respond. This scenario evaluates the code-switching capability of a model to handle more complex use cases. This evaluation tests if the LLM is able to generate a response in a given language and follow the instructions for the language irrespective of which language is used in the questions and/or topics. Users interacting with an LLM in different languages expect the LLM to respond in the same language. Hence, this case tests the LLM's ability to follow instructions to answer in a specified language.

### 4.2 Example Reasoning and Correctness Prompts

### Reasoning and Correctness/Code-Switching Prompts

Case 1: In this example, the prompt remains the same as the prompt used for the instruction following task testing except that the context included with the instruction in the prompt is changed to assess the LLMs reasoning and correctness performance. The framework accesses a standard dataset that already has ground truth answers for the questions provided in the prompt. The evaluation framework uses ROUGE metric scoring to score models'responses by measuring semantic similarity between a response and a corresponding ground-truth to classify if the response generated by the model is correct or not.
Case 2: Case 2 is a more difficult task whose evaluation framework includes three different languages in a prompt. The languages of a {Question} and associated {Topics} are different from each other, and the {Language} in which the model is instructed to respond is different. For example, a prompt includes a question asked in Chinese language, context (e.g., documents) in English, and a request to response in Spanish. This presents a scenario where the user context of data can be in a different language than a preferred language of a user interacting with the LLM. Accuracy of the response is used as an evaluation metric.
Case 3: In this example, a prompt includes five topics that are in five different languages. The responses of LLMs are evaluated against ground truths to result in accuracy measures for the LLMs. These metrics facilitate research, benchmarking, targeted training, and creation of deployment conditions. The evaluation framework facilitates progress towards a single LLM having high multi-lingual capabilities.

### 4.3 Example Consistency Evaluation Prompts

### Consistency Evaluation

Case 1: In this example, the language model evaluation framework prompts an LLM with topics from a standard dataset and asks the LLM five deterministic questions in different languages in the same prompt, for which the model is instructed to reply with either “Yes” or “No”. In this example, the framework evaluates the ability of the model to handle code-switching while being factually correct. With the answer space restricted to Yes/No, the framework directly compares an LLM's response against a ground truth for accuracy to assess the LLM in a closed-set generation space task setup.
Prompt:
“You are given a passage of text followed by a set of questions related to that passage. Your task is to read the passage carefully and respond to each question as either Yes or No. Ensure that the answers are based solely on the information provided in the passage.
Output Format: Provide your answers in a numbered list format, corresponding to the order of the questions. Do not include any additional information or restate the questions.
Passage: {passage}
Questions:
1. {Question 1 in Language 1}
2. {Question 2 in Language 2}
3. {Question 3 in Language 3}
4. {Question 4 in Language 4}
5. {Question 5 in Language 5}”
Case 2:

In this example, the model evaluation framework asks an LLM to answer a same question about a topic selected from a standard dataset in five different languages. The goal is to ensure that the LLM has a semantically similar generated response (>0.95 cosine similarity) in the desired languages. If the semantic similarity is above the threshold (e.g., 0.95), then it is considered as consistent (accuracy metrics). This evaluation aims to facilitate automation and consistency of open-ended source generation. This evaluation helps to assess the multilingual reasoning across different languages and for code-switching between environments for the LLM.
Prompt:
“You are given a passage of text followed by a set of questions related to that passage. Your task is to read the passage carefully and provide concise answers to the question in {language}. Ensure that the answers are based solely on the information provided in the passage.
Passage: {passage}
Question: {question}”

In this example, the framework changes the {language} to different languages and instructs the target model to generate a response multiple times for the different languages. The framework measures cosine similarity between the generated responses and the standard deviation in the cosine similarity. Lower standard deviation and higher average cosine similarity implies consistency of the LLM in reasoning and generating answers across different languages. Cosine similarity between the generated answers is computed by using multilingual text embedding models, like language-agnostic BERT sentence embedding (LABSE), or by translating the responses to English (or another language) and then computing the similarity.

### 4.4 Example Multilingual Task Evaluation, Evaluation-Based LLM Selection, Evaluation-Based LLM Tuning, and Evaluation-Based LLM Deployment

FIG. 3A illustrates a bar graph 310 displaying token counts for three language models for four different languages. However, more or fewer language models and/or languages are used in other embodiments. As shown, for language A, a first token count for the first model is represented by bar 311a, a second token count for the second model is represented by bar 311b, and a third token count for the third model is represented by bar 311c.

Likewise, for language B, a first token count for the first model is represented by bar 312a, a second token count for the second model is represented by bar 312b, and a third token count for the third model is represented by bar 312c. For language C, a first token count for the first model is represented by bar 313a, a second token count for the second model is represented by bar 313b, and a third token count for the third model is represented by bar 313c. For language D, a first token count for the first model is represented by bar 314a, a second token count for the second model is represented by bar 314b, and a third token count for the third model is represented by bar 314c. For other tokens not related to languages A, B, C, or D, a first token count for the first model is represented by bar 315a, a second token count for the second model is represented by bar 315b, and a third token count for the third model is represented by bar 315c.

FIG. 3B illustrates a bar graph 320 displaying total token counts of Model A, Model B, and Model C. The total token count for Model A is represented by bar 322a; the total token count for Model B is represented by bar 322b; and the total token count for Model C is represented by bar 322c.

FIG. 3C illustrates pie charts for displaying distributions of language tokens for Model A, Model B, and Model C. As shown, a first pie chart 325a displays a distribution of language tokens for Model A, a second pie chart 325b displays a distribution of language tokens for Model B, and a third pie chart 325c displays a distribution of language tokens for Model C. In this example, the pie charts 325a, 325b, and 325c include sections for Language A, Language B, Language C, Language D, and for other tokens not related to Language A, Language B, Language C, or Language D. In some embodiments, shared tokens are not counted towards the token count for a particular language.

To determine a token score for a language for a model, the evaluation framework identifies shared tokens that are shared between two or more languages. In this case, a shared token is a token that represents a word or subword that is used in multiple languages. For example, the token “no” is a word in English, Spanish, and Italian. However, the token “no” is part of the word “notion” in French and is therefore also a subword in French. Thus, the token “no” is a shared token between English, Spanish, Italian, and French. In another example, the token “vo” is a subword for “volume” in English and “voila” in French. Thus, the token “vo” is considered as a shared token for English and French but not for languages for which no word in the vocabulary of the language has “vo” as a subword unit.

FIG. 3D illustrates example model selection, prompt generation, and response generation for evaluation of a first LLM and a second LLM. In the example of FIG. 3D, a GUI displays a set of language models and a set of languages. In embodiments, a user inputs a selection into a user device that is displayed by the GUI 332. The computing device receives a selection and/or confirmation of languages and/or models from a user and transmits the selection and/or confirmation to the evaluation framework. The framework evaluates the selected models for the selected languages for a token score, a fine-tuning performance score, a baseline viability (or “multilingual capacity”) score, a multilingual instruction following score, a multilingual reasoning and correctness score, and a multilingual consistency score. In this example, the GUI displays a selection of a first model, Model A 334, and a second model, Model B 336, for evaluation for Language B, Language C, and Language D. In the example, the GUI does not show a selection for a third model, Model Beta. In various embodiments, Model Beta is not selected responsive to user input and/or responsive to a score being below a threshold (e.g., responsive to a low token score and/or a low fine tuning performance score).

As shown, the evaluation framework generates one or more prompts 333. The prompt(s) 333 include a multilingual instruction following evaluation task, a multilingual reasoning and correctness evaluation task, and a multilingual consistency evaluation task.

The evaluation framework accesses one or more responses 335a from the first model 334. The evaluation framework determines a token score 337a for the first model 334 and a fine-tuning performance score 337b for the first model 334. The framework scores the one or more responses 335a. For example, the framework scores a response for accuracy in terms of exact match correctness, semantic similarity, and/or cosine similarity. The framework scores the response for an instruction following task score 337c, a reasoning and correctness task score 337d, and/or a consistency task score 337e.

Likewise, the evaluation framework accesses one or more responses 335b from the second model 336. The evaluation framework determines a token score 339a for the second model 336 and a fine-tuning performance score 339b for the second model 336. The framework scores the one or more responses 335b. The framework scores the response for an instruction following task score 339c, a reasoning and correctness task score 339d, and/or a consistency task score 339e.

FIG. 3E illustrates response analysis and score visualization for a first LLM and a second LLM. In FIG. 3E, a first set of evaluation scores 341 (including the token score 337a, the fine-tuning performance score 337b, the instruction following task score 337c, the reasoning and correctness score 337d, and the consistency score 337e) for the first LLM and a second set of evaluation scores 342 (including the token score 339a, the fine-tuning performance score 339b, the instruction following task score 339c, the reasoning and correctness score 339d, and the consistency score 339e) for the second LLM are received by a score compiler 345. The score compiler 345 orders, ranks, and/or groups LLMs based on composite scores for one or more criteria. For example, the score compiler 345 ranks LLMs by a total score for the languages. In another example, the score compiler 345 ranks LLMs by a score for a task type for a particular language based on a selection of the language and the task type.

In the example, the system organizes a first plurality of language ratings for the first model 334 and a second plurality of language ratings for the second model 336 in a GUI 350. An example language rating is an average or total of an instruction following task score, a reasoning and correctness score, and a consistency score for a language. Another example language rating is conditional on a token score and a fine-tuning support score. In the example, ratings are not determined for the third model, Model Beta, responsive to Model Beta not being selected by a user, having too low a token score, and/or having too low a fine-tuning performance score.

FIG. 3F illustrates LLM selection and deployment for a language based on an evaluation of the first LLM and the second LLM. In FIG. 3F, the system indicates in a GUI 362 that Model A exceeds a threshold score or scores for Language D. Responsive to the Model A exceeding the threshold score, Model A is deployed in a cloud service 364 to service a chatbot agent 366 to generate responses to prompts in Language D.

FIG. 3G illustrates LLM selective fine-tuning and deployment based on an evaluation of the first LLM and the second LLM. In FIG. 3G, a GUI report 372 for Model A and Model B for Language B indicates that Model B has a high token score and a high fine-tuning performance score. Based on the high token score and high fine-tuning performance score, the GUI includes an indication that Model B is a top rank or candidate for fine-tuning for Language B. In this example, Model A is not indicated as a candidate for fine-tuning for language B because the token score and/or fine-tuning performance score did not satisfy a threshold or criteria.

In FIG. 3G, the multilingual language model evaluation framework applies one or more training and/or fine-tuning techniques to an LLM. For example, the system performs reinforcement learning on Model B by causing the model to perform instruction following tasks, reasoning and correctness tasks, and/or language consistency tasks. In the example of FIG. 3G, the training corpus used by a machine learning framework 376 is weighed according to the scores for Model B for Language B for instruction following, reasoning and correctness, and/or consistency. In other embodiments, a training corpus used by a machine learning framework is weighed according to the scores for an LLM for multiple languages according to multiple scores for instruction following, reasoning and correctness, and/or consistency for the multiple languages. For example, a first language scoring five percent higher for a task for an LLM is given a five percent penalty to a loss function during training or tuning of the LLM.

In embodiments, a training data generator generates triplets having prompts for task types for which a model has a performance or accuracy below a threshold. In the example, a prompt generator generates instruction following task training data and consistency task training data, but not reasoning and correctness training data, responsive to a higher score for reasoning and correctness and lower scores for instruction following and consistency.

The language model evaluation framework saves computing resources and improves the efficiency of an LLM deployment pipeline. LLMs that do not meet a minimum viability or multilingual capacity score for a set of languages are removed from a set of LLMs considered for a user case. The remaining LLMs are selectively trained and/or fine-tuned based on improving target task types identified by task type scores. Using the language model evaluation framework to determine whether to fine-tune and/or deploy models eliminates wasteful computing resource consumption and provides a high level of granularity for analyzing, visualizing, grouping, and/or organizing multilingual LLM performance metrics.

In the example of FIG. 3G, the system displays a subsequent GUI 378 showing a subsequent set of scores for Model B for Language B after selective fine-tuning of Model B for instruction following tasks and consistency tasks. In embodiments, the system iterates the training and/or fine-tuning one or more additional times. Responsive to the scores for instruction following tasks, reasoning and correctness tasks, and consistency tasks being above a threshold, Model B is deployed in a cloud service 380 to service a chatbot agent 382 to generate responses to prompts in Language B.

### 5. Machine Learning Architecture

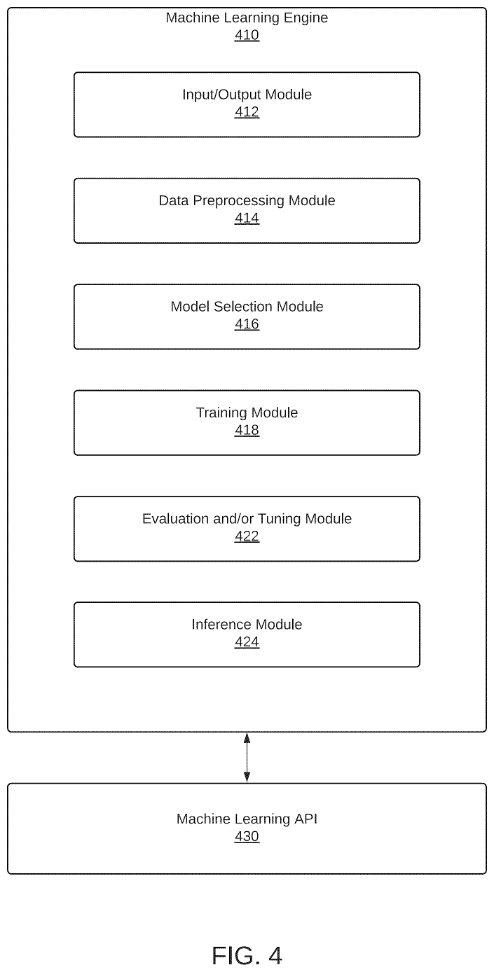

FIG. 4 illustrates a machine learning engine 410 in accordance with one or more embodiments. As illustrated in FIG. 4, machine learning engine 410 includes input/output module 412, data preprocessing module 414, model selection module 416, training module 418, evaluation and tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the machine learning architecture.

In an embodiment, an input handler within input/output module 412 includes a data ingestion framework capable of interfacing with various data sources, such as databases, Application Programming Interfaces (API)s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and accuracy as the data landscape changes. Evaluation and tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 422 performs continuous model tuning by using hyperparameter optimization. Evaluation and tuning module 422 performs an exploration of the hyperparameter space using algorithms, such as grid search, random search, or more sophisticated methods like Bayesian optimization. Evaluation and tuning module 422 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 422 integrates data feedback and updates the model. Evaluation and tuning module 422 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The Machine Learning API 430 is an interface that facilitates access to and interaction with the machine learning engine 410 by other modules and/or components of a system.

### 6. Machine Learning Operations

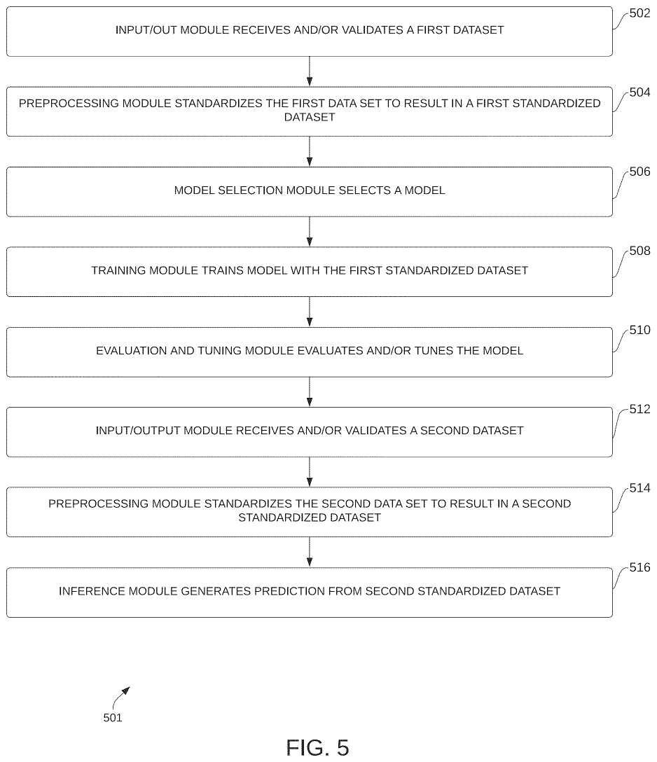

FIG. 5 illustrates a set of machine learning operations 500. In embodiments, one or more operations of the set of operations 500 is performed by a machine learning engine such as machine learning engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and tuning module 422 evaluates the trained model's performance using the validation dataset (Operation 510). Evaluation and tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new data set intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 430 allows for applications to leverage machine learning engine 410. In an embodiment, machine learning engine API 430 may be built on a RESTful architecture and offer stateless interactions over standard HTTP/HTTPS protocols. Machine learning engine API 430 may feature a variety of endpoints, each tailored to a specific function within machine learning engine 410. In an embodiment, endpoints, such as/submitData, facilitate the submission of new data for processing, while/retrieveResults is designed for fetching the outcomes of data analysis or model predictions. The message level encryption (MLE) API also includes endpoints, such as/updateModel for model modifications and/trainModel to initiate training with new datasets.

In an embodiment, machine learning engine API 430 is equipped to support SOAP-based interactions. This extension involves defining a Web Services Description Language (WSDL) document that outlines the API's operations and the structure of request and response messages. In an embodiment, machine learning engine API 430 supports various data formats and communication styles. In an embodiment, machine learning engine API 430 endpoints may handle requests in JSON format or any other suitable format. For example, machine learning engine API 430 may process XML, and it may also be engineered to handle more compact and efficient data formats, such as Protocol Buffers or Avro, for use in bandwidth-limited scenarios.

In an embodiment, machine learning engine API 430 is designed to integrate WebSocket technology for applications necessitating real-time data processing and immediate feedback. This integration enables a continuous, bi-directional communication channel for a dynamic and interactive data exchange between the application and machine learning engine 410.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as GPUs (Graphics Processing Units) or TPUs (Tensor Processing Units), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data that causes data to be moved into a data cloud.

In one or more embodiments, the exposed actions may receive, as input, a request to increase or decrease existing alert thresholds. The input might identify existing in-application alert thresholds and whether to increase, decrease, or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

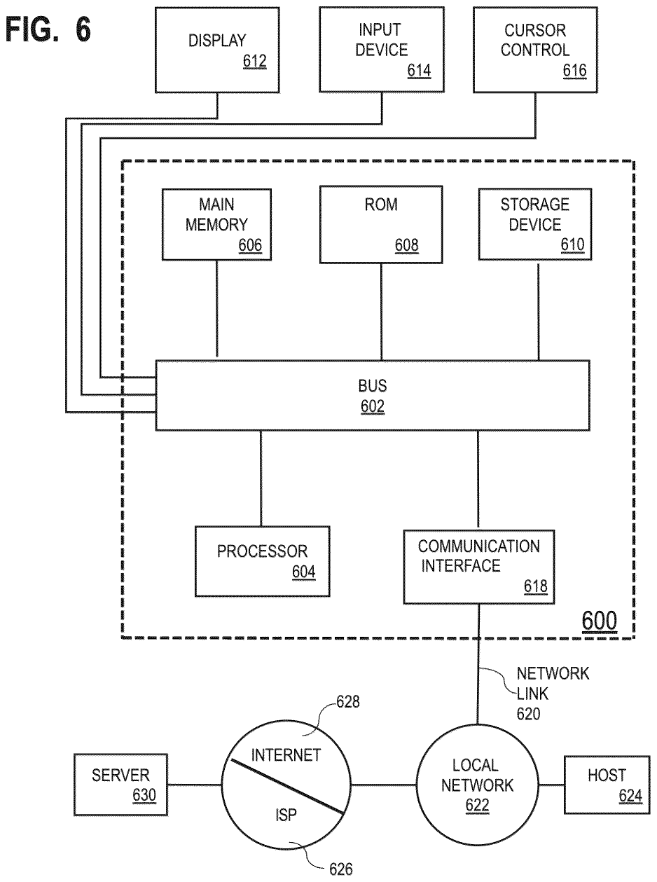

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. ________________________________________________

What is claimed is:

1. A method for evaluating one or more large language models for multilingual performance, comprising:
accessing a large language model (LLM), a context, a question, and an answer;
generating a prompt, the prompt comprising a first instruction to generate a specified response in a specified language based on the context and the question;
generating an output by providing the prompt as input into the LLM, wherein at least one of the question, first instruction, context, and answer are in a second language different from the specified language;
evaluating, based on a comparison of a contents of the output to the answer, at least one of: (a) an ability of the LLM to respond in the specified language for a multilingual task; (b) an ability of the LLM to reason correctly for a multilingual task; or (c) an ability of the LLM to respond consistently for a plurality of languages;
wherein the method is performed by at least one device including a hardware processor.

2. The method of claim 1, wherein:
the prompt includes an instruction following task comprising:
instructions, in a first language, to respond to the prompt with an indication of whether the context answers the question.

3. The method of claim 1, wherein:
the context comprises a title in the second language and a text in the second language; and
the question is in the second language and is related to a topic associated with the title.

4. The method of claim 1, wherein:
the question is in the second language, the context is in the specified language, and the prompt includes a second instruction to respond in a third language.

5. The method of claim 1, wherein:
the prompt includes a second instruction to indicate whether the context answers the question based on correlation between the context and a ground truth.

6. The method of claim 5, wherein:
the indication comprises an indication whether a language of the output matches a language of a ground truth.

7. The method of claim 1, wherein:
the prompt includes a second instruction to respond to the prompt in the specified language; the method comprising:
determining a language of the output; and
labelling the output as inaccurate responsive to determining that the output is not in the specified language.

8. The method of claim 1, wherein:
the prompt includes a second instruction to respond to the prompt in a same language as the question; the method comprising:
determining a language of the output; and
labelling the output as inaccurate responsive to determining that the output is not in the same language as the question.

9. The method of claim 1, comprising:
evaluating the output by comparing the output to a ground-truth using recall-oriented understudy for gisting evaluation (ROUGE) metrics.

10. The method of claim 1, wherein:
the question is a first question of a plurality of questions in the second language and the context is a first context of a plurality of contexts in the second language.

11. The method of claim 1, wherein:
the question is a first question of a plurality of questions in different languages and the context is a first context of a plurality of contexts in different languages.

12. The method of claim 11, wherein:
the plurality of questions in different languages comprises a same question translated into different languages; and
the plurality of contexts in different languages comprises one or more same contexts translated into different languages.

13. The method of claim 1, wherein:
the prompt includes a multilingual consistency task prompt comprising:
answering a plurality of deterministic questions in a plurality of languages and an instruction to indicate, in the output, a plurality of yes or no answers for the plurality of deterministic questions based solely on the context; and
comparing the plurality of yes or no answers to a ground truth to determine an accuracy of the output.

14. The method of claim 1, comprising:
generating a total score as weighted sum of a score for the ability of the LLM to respond in the specified language for the multilingual task, a score for the ability of the LLM to reason correctly for the multilingual task, and a score for the ability of the LLM to respond consistently for the plurality of languages.

15. The method of claim 14 comprising:
training the LLM using a standard data set to generate a trained LLM, the standard data set comprising one or more pairs of question, context, answer triplets, the one or more pairs comprising a first triplet in the specified language paired with a second triplet in the second language;
generating a baseline score for the LLM;
computing a feedback score based on comparing a second score for the trained LLM to the baseline score for the LLM; and
computing a final score based on the feedback score and the total score.

16. The method of claim 15, comprising:
training the LLM using the standard data set to generate a trained LLM using at least one training method selected from: parameter efficient fine-tuning, vocabulary extension tuning, and instructional tuning.

17. The method of claim 14, comprising:
calculating a token score for the LLM based on a size of a vocabulary of the LLM and on a language distribution of tokens in the vocabulary, wherein the total score is based at least in part on a weighting of the token score.

18. One or more non-transitory computer readable media comprising:
instructions which, when executed by one or more hardware processors, cause performance of operations comprising:
accessing a large language model (LLM), a context, a question, and an answer;
generating a prompt, the prompt comprising a first instruction to generate a specified response in a specified language based on the context and the question;
generating an output by providing the prompt as input into the LLM, wherein at least one of the question, first instruction, context, and answer are in a second language different from the specified language;
evaluating, based on a comparison of a contents of the output to the answer, at least one of: (a) an ability of the LLM to respond in a specified language for a multilingual task; (b) an ability of the LLM to reason correctly for a multilingual task; or (c) an ability of the LLM to respond consistently for a plurality of languages.

19. The non-transitory computer readable media of claim 18, wherein:
the prompt includes an instruction following task comprising instructions, in a first language, to respond to the prompt with an indication of whether the context answers the question;
the context comprises a title in the second language and a text in the second language;
the question is in the second language and is related to a topic associated with the title;
the question is in the second language, the context is in the specified language, and the prompt includes a second instruction to respond in a third language;
the prompt includes a second instruction to indicate whether the context answers the question based on correlation between the context and a ground truth;
the indication comprises an indication whether a language of the output matches a language of a ground truth;
the prompt includes a second instruction to respond to the prompt in the specified language; and
the prompt includes a second instruction to respond to the prompt in a same language as the question;
the operations further comprising:
determining a language of the output;
labelling the output as inaccurate responsive to determining that the output is not in the specified language;
determining a language of the output; and
labelling the output as inaccurate responsive to determining that the output is not in the same language as the question.

20. A system comprising:
at least one device including a hardware processor;
the system being configured to perform operations comprising:
accessing a large language model (LLM), a context, a question, and an answer;
generating a prompt, the prompt comprising a first instruction to generate a specified response in a specified language based on the context and the question;
generating an output by providing the prompt as input into the LLM, wherein at least one of the question, first instruction, context, and answer are in a second language different from the specified language;
evaluating, based on a comparison of a contents of the output to the answer, at least one of:
(a) an ability of the LLM to respond in a specified language for a multilingual task;
(b) an ability of the LLM to reason correctly for a multilingual task; or (c) an ability of the LLM to respond consistently for a plurality of languages.
